(19) United States
(12) Patent Application Publication
(10) Pub. No.: US 2017/0061384 A1
(43) Pub. Date: Mar. 2, 2017

(54) SERVER, PROPOSAL METHOD, PROPOSAL SYSTEM, AND NOTIFICATION APPARATUS

(71) Applicant: SHARP KABUSHIKI KAISHA, Sakai City, Osaka (JP)

(72) Inventor: Motoki SONE, Sakai City, Osaka (JP)

(73) Assignee: SHARP KABUSHIKI KAISHA, Sakai City, Osaka (JP)

(21) Appl. No.: 15/120,376

(22) PCT Filed: Mar. 27, 2015
(86) PCT No.: PCT/JP2015/059683

§ 371 Date: Aug. 19, 2016

(30) Foreign Application Priority Data
Apr. 1, 2014 (JP) 2014-075707

(51) Int. Cl. G06Q 10/10; H04L 29/08

(52) U.S. Cl. CPC G06Q 10/1093; H04L 67/10

(57) ABSTRACT

The present invention is a server including: a calendar information obtaining section for obtaining calendar information; a suggestion content determining section for determining suggestion content for each notification device by referring to the calendar information; and a suggestion content providing section for providing, to an electrical device for notifying the suggestion content, suggestion content information indicative of the suggestion content.

### TECHNICAL FIELD

The present invention relates to a server, a program, a suggestion method, and a suggestion system, each of which is for controlling a notification device to notify suggestion content, and the notification device.

### BACKGROUND ART

There has been conventionally disclosed a technique for making a suggestion to a user by use of an electrical device installed in a home.

For example, Patent Literature 1 discloses an information processing device for proposing, in accordance with operation/time information and restriction information, a schedule for operating two or more electronic devices. The operation/time information includes (i) operation information on an operation of an electronic device and (ii) time information on a time at which the electronic device was operated. The restriction information is information on a restriction in a case where an electronic device is operated.

### CITATION LIST

### [Patent Literature]

Patent Literature 1

Japanese Patent Application Publication, Tokukai, No. 2004-259116 (Publication date: Sep. 16, 2004)

### SUMMARY OF INVENTION

### Technical Problem

However, since the technique disclosed in Patent Literature 1 merely proposes a schedule for operating an electronic device in accordance with an operation history of the electronic device, the technique has a problem in prompting a user to notice a matter concerning the future.

The present invention has been accomplished in view of the problem, and an object of the present invention is to provide a technique for making, to a user, a suggestion prompting the user to notice a matter concerning the future.

### Solution to Problem

In order to attain the object, a server in accordance with an aspect of the present invention includes: a calendar information obtaining section for obtaining calendar information; a suggestion content determining section for determining suggestion content for each notification device by referring to the calendar information; and a suggestion content providing section for providing suggestion content information indicative of the suggestion content to the each notification device for notifying the suggestion content.

In order to attain the object, a suggestion method in accordance with an aspect of the present invention includes the steps of: obtaining calendar information; determining suggestion content for each notification device by referring to the calendar information; and providing suggestion content information indicative of the suggestion content to the each notification device for notifying the suggestion content.

In order to attain the object, a suggestion system in accordance with an aspect of the present invention is a suggestion system including a server and a notification device, the server including: a calendar information obtaining section for obtaining calendar information; a suggestion content determining section for determining suggestion content for each notification device by referring to the calendar information; and a suggestion content providing section for providing suggestion content information indicative of the suggestion content to the each notification device for notifying the suggestion content, the each notification device including: a suggestion content obtaining section for obtaining the suggestion content information from the server, and a notifying section for notifying the suggestion content indicated by the suggestion content information obtained by the suggestion content obtaining section.

In order to attain the object, an electrical device in accordance with an aspect of the present invention includes an operation information output section for outputting operation information indicative of an operation received from a user; a suggestion content obtaining section for obtaining suggestion content information indicative of suggestion content that has been determined by referring to the operation information and calendar information; and a notifying section for notifying the suggestion content indicated by the suggestion content information obtained by the suggestion content obtaining section.

### Advantageous Effects of Invention

An aspect of the present invention makes it possible to make, to a user, a suggestion prompting the user to notice a matter concerning the future.

### BRIEF DESCRIPTION OF DRAWINGS

FIG. 1 is a view schematically illustrating a suggestion system in accordance with Embodiment 1 of the present invention.

FIG. 2 is a block diagram illustrating a configuration of the suggestion system in accordance with Embodiment 1 of the present invention.

FIG. 3 is a block diagram schematically illustrating a hardware configuration of the suggestion system in accordance with Embodiment 1 of the present invention.

FIG. 4 is a view showing a calendar table of the suggestion system in accordance with Embodiment 1 of the present invention.

FIG. 5 is a sequence diagram showing a flow of a process of updating the calendar table in the suggestion system in accordance with Embodiment 1 of the present invention.

FIG. 6 is a view illustrating a screen for updating the calendar table in the suggestion system in accordance with Embodiment 1 of the present invention.

FIG. 7 is a view showing a lifestyle suggestion table of the suggestion system in accordance with Embodiment 1 of the present invention.

FIG. 8 is a sequence diagram showing a flow of a process of notifying suggestion content in the suggestion system in accordance with Embodiment 1 of the present invention.

FIG. 9 is a sequence diagram showing a flow of a process of determining suggestion content in the suggestion system in accordance with Embodiment 1 of the present invention.

FIG. 10 is a view illustrating how a refrigerator notifies suggestion content in a suggestion system in accordance with Embodiment 2 of the present invention.

### DESCRIPTION OF EMBODIMENTS

### Embodiment 1

The following description will discuss in detail an embodiment of the present invention. A description of a configuration other than those described in specific embodiments below may be omitted as necessary. Note, however, that in a case where such a configuration is described in another embodiment, the configuration is identical to that described in the another embodiment. For convenience, members identical in function to those described in the embodiments are given identical reference numerals, and descriptions of those members are omitted as appropriate.

(Suggestion System 1)

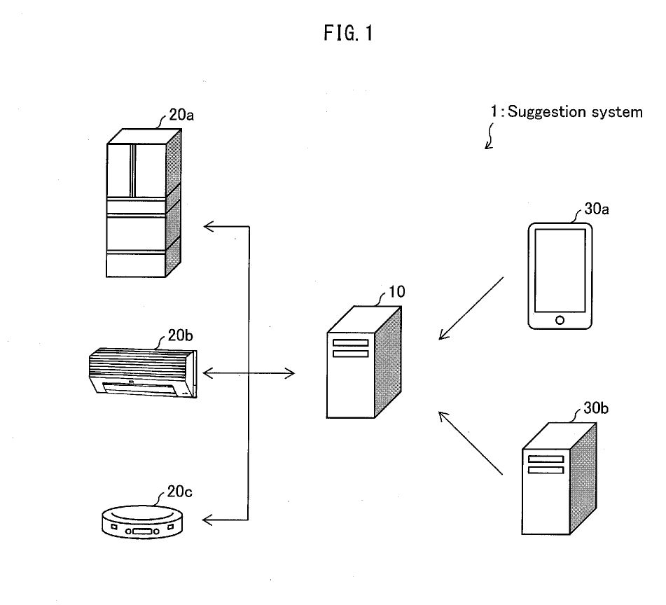

FIG. 1 is a view schematically illustrating a suggestion system 1 in accordance with Embodiment 1 of the present invention. As illustrated in FIG. 1, the suggestion system 1 includes (i) a server 10, (ii) a refrigerator 20a, an air conditioner 20b, and a robot vacuum cleaner 20c (hereinafter collectively referred to as electrical device 20), and (iii) a smartphone 30a and a PC 30b (hereinafter collectively referred to as calendar updated information input device 30).

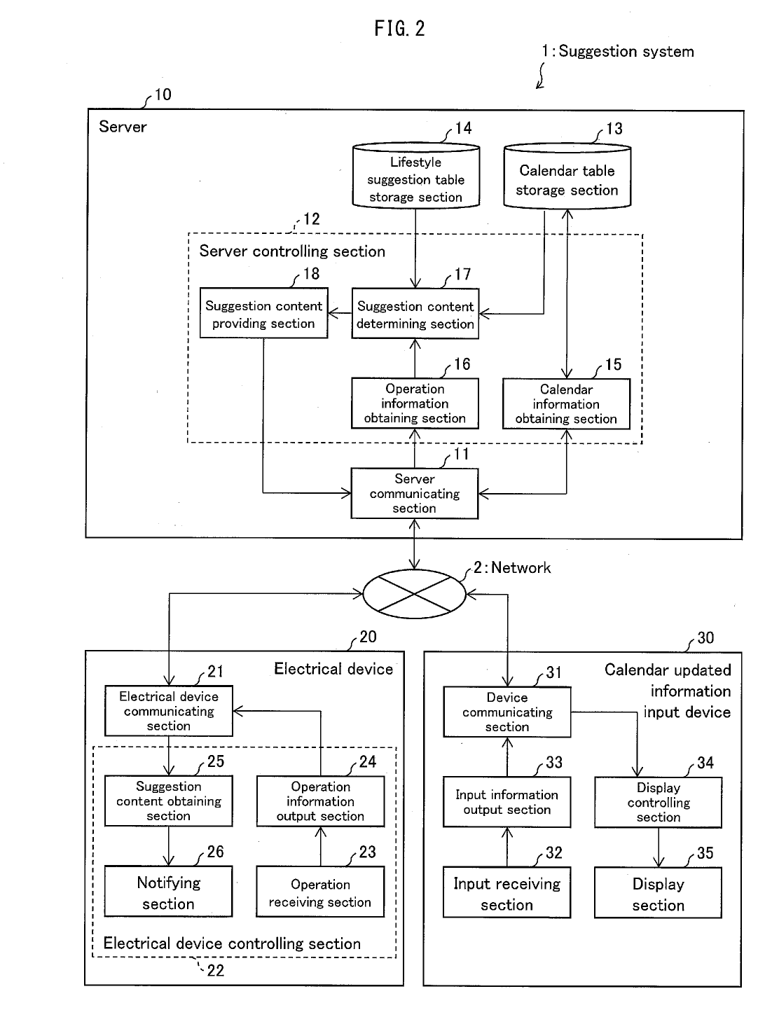

In the suggestion system 1, the server 10 determines suggestion content by referring to calendar information obtained from the calendar updated information input device 30. The server 10 is capable of making a suggestion to a user by controlling the electrical device 20 to notify the suggestion content thus determined. The following description will discuss in detail the suggestion system with reference to FIG. 2. FIG. 2 is a block diagram illustrating a configuration of the suggestion system 1 in accordance with Embodiment 1 of the present invention.

Note that the calendar information is information including information concerning the future such as a schedule of a user and a weather forecast. The information included in the calendar information is managed, for example, in a table format as a calendar table. Note, however, that Embodiment 1 is not limited to this, and the calendar information can be managed in a format other than the table format.

(Server 10)

As illustrated in FIG. 2, the server 10 includes a server communicating section 11, a server controlling section 12, a calendar table storage section 13, and a lifestyle suggestion table storage section 14.

The server communicating section 11 functions to transmit/receive data to/from the electrical device 20 and the calendar updated information input device 30 via a network 2.

The calendar table storage section 13 stores a calendar table. Information included in the calendar table is changeable by obtaining calendar updated information from the calendar updated information input device 30. A process of updating the calendar table will be described later in detail.

The lifestyle suggestion table storage section 14 stores a lifestyle suggestion table in which suggestion information is managed in a table format. The suggestion information is information concerning a suggestion to be notified by the suggestion system 1. The lifestyle suggestion table will be described later in detail.

The server controlling section 12 comprehensively controls configurations of the server 10. The following description will discuss in detail the server controlling section 12.

(Server Controlling Section 12)

As illustrated in FIG. 2, the server controlling section 12 also functions as a calendar information obtaining section 15, an operation information obtaining section 16, a suggestion content determining section 17, and a suggestion content providing section 18.

The calendar information obtaining section 15 (i) controls the server communicating section 11 to obtain calendar updated information that the server communicating section 11 has received and (ii) reflects, to the calendar table, calendar information included in the calendar updated information. Further, the calendar information obtaining section 15 obtains calendar information from the calendar table storage section 13 and transmits the calendar information to the calendar updated information input device 30 via the server communicating section 11.

The operation information obtaining section 16 controls the server communicating section 11 to obtain operation information that the server communicating section 11 has received. Note that the operation information is information which is received from the electrical device 20. The operation information includes (i) information indicative of the electrical device 20 and (ii) information indicative of content of an operation received by the electrical device 20. Note that the information indicative of the electrical device 20 is information indicating that which of one or more candidate electrical devices is the electrical device 20.

The suggestion content determining section 17 determines suggestion content to be suggested to a user, by referring to (i) the calendar table stored in the calendar table storage section 13 and (ii) the lifestyle suggestion table stored in the lifestyle suggestion table storage section 14. A process in which the suggestion content determining section 17 determines suggestion content will be described later in detail.

The suggestion content providing section 18 provides, to the electrical device 20 via the server communicating section 11, suggestion content information indicative of the suggestion content determined by the suggestion content determining section 17.

(Electrical Device 20)

As illustrated in FIG. 2, the electrical device 20 includes an electrical device communicating section 21 and an electrical device controlling section 22.

The electrical device communicating section 21 has a function of transmitting/receiving data to/from the server 10 via the network 2.

The electrical device controlling section 22 comprehensively controls configurations of the electrical device 20. The following description will discuss in detail the electrical device controlling section 22.

(Electrical Device Controlling Section 22)

As illustrated in FIG. 2, the electrical device controlling section 22 also functions as an operation receiving section 23, an operation information output section 24, a suggestion content obtaining section 25, and a notifying section 26.

The operation receiving section 23 (i) receives an operation that is carried out by a user with respect to the electrical device 20 and (ii) outputs operation information indicative of (a) the electrical device 20 operated by the user and (b) content of the operation thus received.

The operation information output section 24 supplies, to the server 10 via the electrical device communicating section 21, the operation information outputted from the operation receiving section 23.

The suggestion content obtaining section 25 controls the electrical device communicating section 21 to obtain suggestion content information that the electrical device communicating section 21 has received.

The notifying section 26 notifies suggestion content indicated by the suggestion content information obtained by the suggestion content obtaining section 25. Examples of a method in which the notifying section 26 notifies suggestion content encompass (i) a method in which suggestion content is displayed as text or an image on a display such as a liquid crystal panel or an organic EL display and (ii) a method in which suggestion content is outputted as a voice from a speaker.

As illustrated in FIG. 1, Embodiment 1 discusses a refrigerator, an air conditioner, and a robot vacuum cleaner as examples of the electrical device 20. Note, however, that the electrical device of the present specification is not limited to these. The electrical device of the present specification can be any electrical device that is used daily by a user. In addition to the examples mentioned above, examples of the electrical device of the present specification encompass a television, an air cleaner, an electric fan, a video recorder, an audio player, a washing machine, a beauty home electrical appliance, a rice cocker, a microwave oven, an oven, and a dish washing machine. In recent years, there have been (i) a system which is called a home energy management system (HEMS) and manages electric power in households and (ii) a device for operating the HEMS. Examples of the electrical device of the present specification encompass the above system and device.

In Embodiment 1, the electrical device 20 also functions as a notification device for notifying suggestion content. Accordingly, among electrical devices described in the present specification, Embodiment 1 discusses an electrical device including the notifying section 26. Note, however, that any electrical device can be among the electrical devices in the present specification, provided that in a case where a user operates the electrical device, the electrical device supports life of the user by, for example, improving convenience of daily life, health, and saving effect of the user. For example, Embodiment 3 described later discusses, as an example, a configuration in which an electrical device including no notifying section 26 transmits operation information.

(Calendar Updated Information Input Device 30)

As illustrated in FIG. 2, the calendar updated information input device 30 includes a device communicating section 31, an input receiving section 32, an input information output section 33, a display controlling section 34, and a display section 35.

The device communicating section 31 functions to transmit/receive data to/from the server 10 via the network 2.

The input receiving section 32 (i) receives information inputted by a user of the calendar updated information input device 30 and (ii) outputs input information indicative of the information thus received.

The input information output section 33 supplies, to the server 10 via the device communicating section 31, the input information outputted from the input receiving section 32.

The display controlling section 34 (i) obtains calendar information received by the device communicating section 31 and (ii) controls the display section 35 to display a screen via which calendar updated information is to be inputted by a user.

The display section 35 is a display for displaying an image and the like. For example, the display section 35 can be realized by a transmissive liquid crystal panel including a backlight, but is not limited to this. The display section 35 can be realized by another display such as an organic EL display.

A process of updating the calendar table by use of the calendar updated information input device 30 will be described later with reference to other drawings.

(Hardware Configuration of Suggestion System 1)

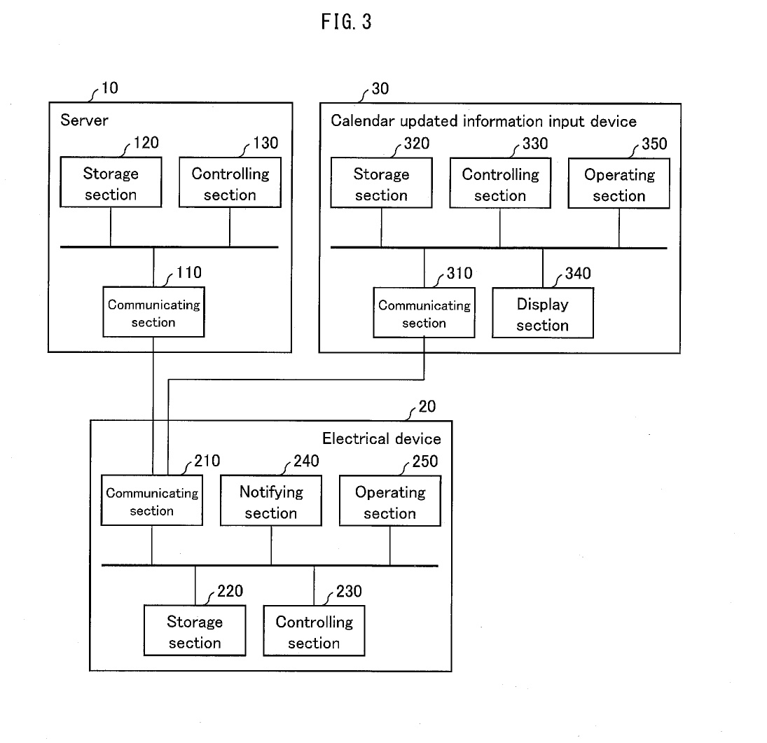

FIG. 3 is a block diagram schematically illustrating a hardware configuration of the suggestion system 1 in accordance with Embodiment 1 of the present invention.

(Hardware Configuration of Server 10)

As illustrated in FIG. 3, the server 10 includes a communicating section 110, a storage section 120, and a controlling section 130.

The communicating section 110 is an interface for enabling communication with each of the electrical device 20 and the calendar updated information input device 30. The communicating section 110 realizes a function of the server communicating section 11 described above.

The storage section 120 includes a main storage section and an auxiliary storage section. Examples of a device usable as the main storage section of the storage section 120 encompass a semiconductor random access memory (RAM). Examples of a device usable as the auxiliary storage section of the storage section 120 encompass a hard disk drive (HDD). The auxiliary storage section stores a control program for realizing a function of the server 10. The control program is a program for realizing a function of the server controlling section 12.

The controlling section 130 realizes the function of the server controlling section 12 by (i) loading the control program on the main storage section of the storage section 120 and (ii) executing various instructions contained in the control program thus loaded. Examples of a device usable as the controlling section 130 encompass a central processing unit (CPU).

(Hardware Configuration of Electrical Device 20)

As illustrated in FIG. 3, the electrical device 20 includes a communicating section 210, a storage section 220, a controlling section 230, a notifying section 240, and an operating section 250.

The communicating section 210 is an interface for enabling communication with the server 10. The communicating section 210 realizes a function of the electrical device communicating section 21 described above.

The storage section 220 includes a main storage section and an auxiliary storage section. Examples of a device usable as the main storage section of the storage section 220 encompass a semiconductor RAM. Examples of a device usable as the auxiliary storage section of the storage section 220 encompass a hard disk drive (HDD). The auxiliary storage section stores a control program for realizing a function of the electrical device 20. The control program is a program for realizing a function of the electrical device controlling section 22.

The controlling section 230 realizes the function of the electrical device controlling section 22 by (i) loading the control program on the main storage section of the storage section 220 and (ii) executing various instructions contained in the control program thus loaded. Examples of a device usable as the controlling section 230 encompass a CPU.

The notifying section 240 is a device for notifying suggestion content. Examples of a device usable as the notifying section 240 encompass a display and a speaker.

The operating section 250 is a user interface for receiving an operation to be carried out by a user with respect to the electrical device 20. Examples of a device usable as the operating section 250 encompass a hard key and a switch.

(Hardware Configuration of Calendar Updated Information Input Device 30)

As illustrated in FIG. 3, the calendar updated information input device 30 includes a communicating section 310, a storage section 320, a controlling section 330, a display section 340, and an operating section 350.

The communicating section 310 is an interface for enabling communication with the server 10. The communicating section 310 realizes a function of the device communicating section 31 described above.

The storage section 320 includes a main storage section and an auxiliary storage section. Examples of a device usable as the main storage section of the storage section 320 encompass a semiconductor RAM. Examples of a device usable as the auxiliary storage section of the storage section 320 encompass a hard disk drive (HDD). The auxiliary storage section stores a control program for realizing a function of the calendar updated information input device 30. The control program is a program for realizing functions of the input receiving section 32, the input information output section 33, and the display controlling section 34.

The controlling section 330 realizes the functions of the input receiving section 32, the input information output section 33, and the display controlling section 34 by (i) loading the control program on the main storage section of the storage section 320 and (ii) executing various instructions contained in the control program thus loaded. Examples of a device usable as the controlling section 330 encompass a CPU.

The display section 340 is a device for displaying an image indicated by an image signal outputted from the controlling section 330. The display section 340 realizes a function of the display section 35 described above.

The operating section 350 is a user interface for receiving an operation to be carried out by a user with respect to the calendar updated information input device 30. Examples of a device usable as the operating section 350 encompass a hard key and a touch sensor.

(Calendar Table)

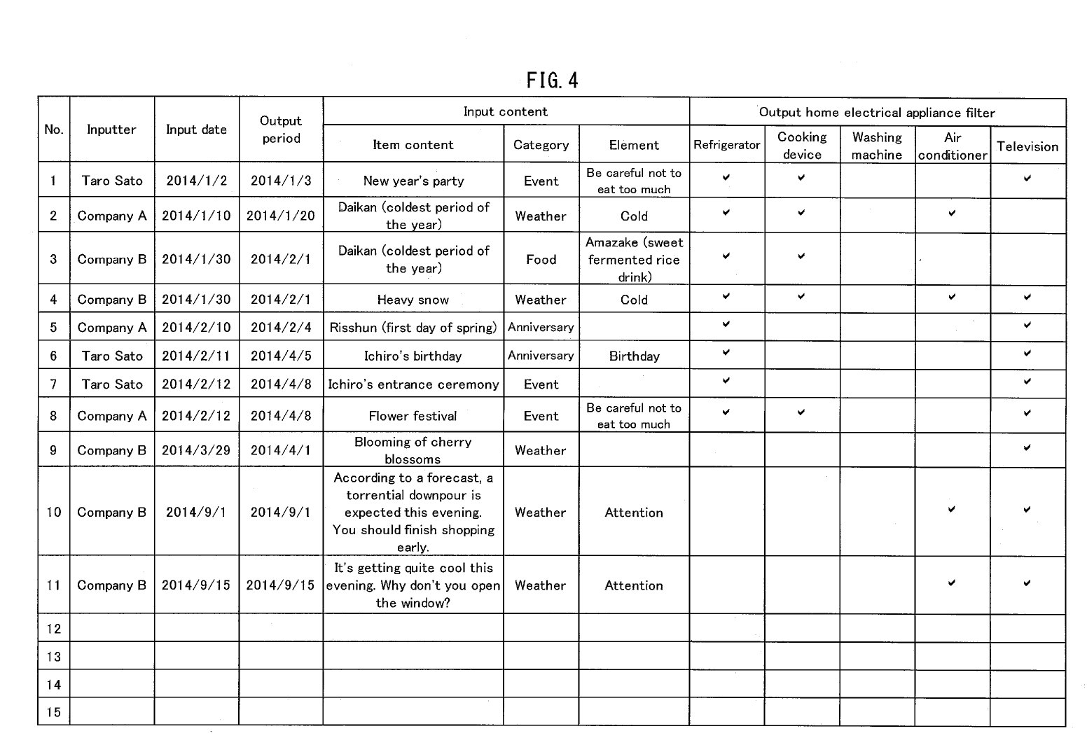

FIG. 4 is a view showing a calendar table of the suggestion system 1 in accordance with Embodiment 1 of the present invention. The following description will discuss the calendar table with reference to FIG. 4. The calendar table shown in FIG. 4 is an example in which a plurality of pieces of calendar information are shown in a table format. The suggestion content determining section refers to the calendar table in order to determine suggestion content to be suggested to a user.

The calendar table storage section 13 stores a calendar table such that the calendar table is associated with each user of the suggestion system 1. The calendar table storage section 13 can be configured such that the calendar table is associated with each user of the suggestion system 1, for example, in accordance with user identification information identifying each user, but the configuration of the calendar table storage section 13 is not limited to this.

As shown in FIG. 4, the calendar table includes items of “inputter”, “input date”, “output period”, “input content”, and “output home electrical appliance filter”. In other words, as shown in FIG. 4, the items of “inputter”, “input date”, “output period”, “input content”, and “output home electrical appliance filter” are each associated with calendar information. Further, serial numbers are assigned to respective rows (respective pieces of calendar information) of the calendar table. Items to which an identical serial number is assigned are managed so as to be associated with each other. In the example shown in FIG. 4, the serial numbers are assigned to the respective rows of the calendar table in order of the “input date”. Note, however, that Embodiment 1 is not limited to this, provided that the rows can be distinguished from each other by the serial numbers.

The item “inputter” is information indicative of an inputter who has inputted the calendar information. The “inputter” may be identical to a user of the suggestion system 1 or differ from the user.

The item “input date” is information indicative of a date on which the calendar information was inputted.

The item “output period” is information indicative of a period that serves as a reference for notifying suggestion content that is determined by referring to corresponding calendar information. In other words, the “output period” of the calendar table indicates a date on which or a period during which a matter indicated by “item content” (described later) occurs.

The output period can be, for example, a period including a plurality of dates such as “2014/1/1 to 2014/1/10”. Alternatively, it is possible to set, as the output period, a start time and an end time such as “2014/1/1 10:00 to 2014/1/1 11:00”.

The item “input content” includes items of “item content”, “category”, and “element”, and indicates content that has been inputted by an inputter.

The “item content” is information of text inputted by an inputter. The example in FIG. 4 shows, for example, “New Year's party”, “Daikan (the coldest period of the year)”, “heavy snow”, and the like as the “item content”. Note, however, that these are merely examples and Embodiment 1 is not limited to these.

The “category” (i) is classification information indicative of a category of each item content and (ii) can be considered as information indicative of an attribute of the “item content”. The “category” is selected by an inputter from a plurality of candidates for the category. Note, however, that Embodiment 1 is not limited to this, and the suggestion system 1 can be configured such that the inputter directly inputs text for the category.

The “element” is information related to the “category”, and options for “element” are determined in accordance with a “category”. For example, in a case where “weather” is selected as the “category”, “cold”, “hot”, “attention”, and the like are set as options for the “element”. In a case where “event” is selected as the “category”, “Be careful not to eat too much” and the like are set as options for the “element”. As described later, an inputter selects, as the element, any of the above options. Note that the “element” may not always be designated.

As described above, the “input content” is managed by being classified into categories, and suggestion content includes a suggestion in accordance with a category of each “input content”. Due to having the above configuration, the suggestion system 1 can make a suggestion more convenient for a user.

The item “output home electrical appliance filter” is information indicative of an electrical device capable of notifying suggestion content among electrical devices. That is, an electrical device that is set as the “output home electrical appliance filter” is a notification device for notifying suggestion content. The output home electrical appliance filter designates, for example, which device among a “refrigerator”, a “cooking device”, a “washing machine”, an “air conditioner”, and a “television” is to serve as a device capable of notifying suggestion content (see FIG. 4). In the example shown in FIG. 4, devices each capable of notifying suggestion content are indicated by “ [symbol] ” (check mark). The “output home electrical appliance filter” (i) can be determined in accordance with the “input content” or (ii) can be determined by an inputter by selecting a device capable of notifying suggestion content. Alternatively, the “output home electrical appliance filter” can be determined such that a part of the electrical devices for the “output home electrical appliance filter” is determined in accordance with the “input content” and the other part of the electrical devices for the “output home electrical appliance filter” is inputted by the inputter.

(Process of Updating Calendar Table)

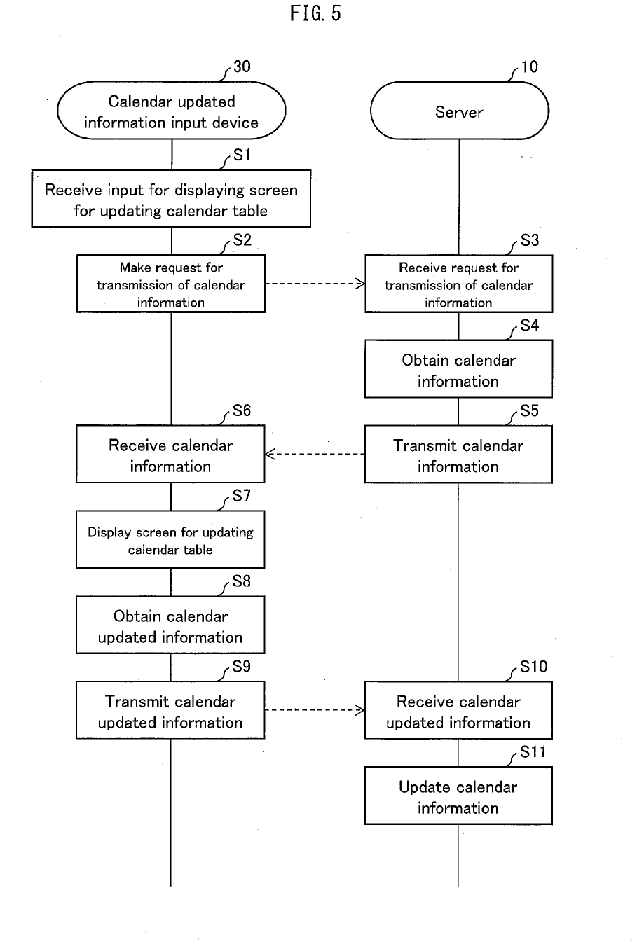

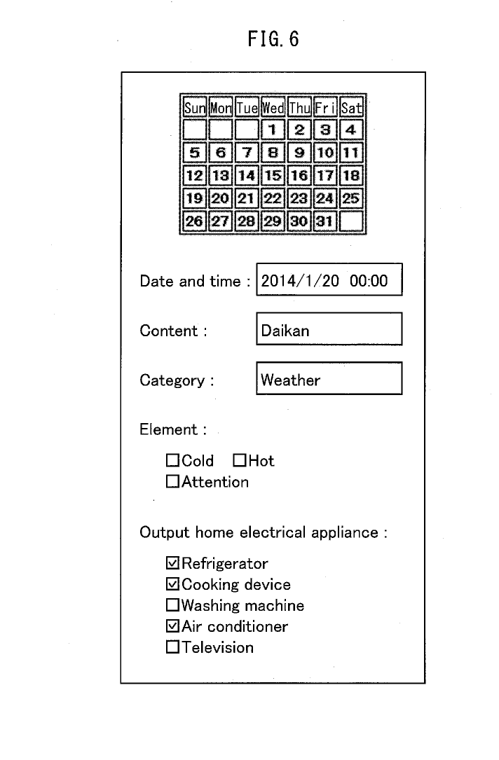

FIG. 5 is a sequence diagram showing a flow of a process of updating the calendar table in the suggestion system 1 in accordance with Embodiment 1 of the present invention. The following description will discuss, with reference to FIGS. 5 and 6, a process of updating a calendar table stored in the calendar table storage section 13.

(Step S1)

First, the input receiving section 32 of the calendar updated information input device 30 receives an input for displaying a screen for updating the calendar table. Note that input information indicating that the input receiving section 32 has received the input for displaying a screen for updating the calendar table includes user identification information identifying a user. The input receiving section 32 supplies, to the input information output section 33, the input information indicative of information thus inputted.

(Step S2)

In a case where the input information output section 33 of the calendar updated information input device 30 obtains, from the input receiving section 32, the input information indicating that the input receiving section 32 has received the input for displaying a screen for updating the calendar table, the input information output section 33 (i) supplies, to the server 10 via the device communicating section 31, the user identification information included in the input information and (ii) makes a request, via the device communicating section 31, for transmission of calendar information.

(Step S3)

The calendar information obtaining section 15 of the server 10 (i) obtains the user identification information from the calendar updated information input device 30 via the server communicating section 11 and (ii) receives, via the server communicating section 11, the request for transmission of calendar information.

(Step S4)

In a case where the calendar information obtaining section 15 receives the request for transmission of calendar information, the calendar information obtaining section 15 obtains, from the calendar table storage section 13, calendar information included in a calendar table of a user indicated by the obtained user identification information.

(Step S5)

The calendar information obtaining section 15 transmits the calendar information thus obtained to the calendar updated information input device 30.

(Step S6)

The display controlling section 34 of the calendar updated information input device 30 receives, via the device communicating section 31, the calendar information transmitted from the server 10.

(Step S7)

The display controlling section 34 displays, in accordance with the calendar information thus received, a screen for updating the calendar table. FIG. 6 illustrates a screen for updating a calendar table. FIG. 6 is a view illustrating a screen, displayed in the suggestion system 1 in accordance with Embodiment 1 of the present invention, for updating a calendar table. An inputter inputs, via the screen for updating the calendar table, the “output period”, the “item content”, the “category”, the “element”, and the “output home electrical appliance filter” of the calendar table.

Information inputted as a “date and time” in FIG. 6 corresponds to the “output period” of the calendar table. Information inputted as “content” in FIG. 6 corresponds to the “item content” of the calendar table. Information inputted as a “category” in FIG. 6 corresponds to the “category” of the calendar table. Information inputted as an “element” in FIG. 6 corresponds to the “element” of the calendar table. Information inputted as an “output home electrical appliance” in FIG. 6 corresponds to the “output home electrical appliance filter” of the calendar table.

Note that, as described above, the “category” can be selected by an inputter from a plurality of candidates for the category. In such a case, for example, the display controlling section 34 can be configured to display, in a part for inputting a “category” in FIG. 6, options in a pull-down menu so that the inputter selects, as the “category”, any of the options thus displayed.

As described above, options for “element” are determined in accordance with a “category”. Accordingly, as illustrated in FIG. 6, the display controlling section 34 can be configured to display options for the “element” so that an inputter selects, by checking a box, any of the options thus displayed. Alternatively, the display controlling section 34 can be configured to display options for the “element” in a pull-down menu so that the inputter selects, as the “element”, any of the options thus displayed.

As illustrated in FIG. 6, the display controlling section 34 can be configured to display, as the “output home electrical appliance”, electrical devices set as the “output home electrical appliance filter” of the calendar table so that the inputter selects, from the electrical devices thus displayed, an electrical device for providing a notification.

(Step S8)

The input receiving section 32 of the calendar updated information input device 30 (i) receives an input for updating the calendar table and (ii) supplies, to the input information output section 33, input information indicative of the input thus received. The input information output section 33 obtains, as calendar updated information, the input information supplied from the input receiving section 32.

(Step S9)

The input information output section 33 transmits the calendar updated information to the server 10 via the device communicating section 31.

(Step S10)

The calendar information obtaining section 15 of the server 10 receives, via the server communicating section 11, the calendar updated information transmitted from the calendar updated information input device 30 (a step of obtaining calendar information).

(Step S11)

The calendar information obtaining section 15 updates the calendar table by referring to the calendar updated information thus received.

(Lifestyle Suggestion Table)

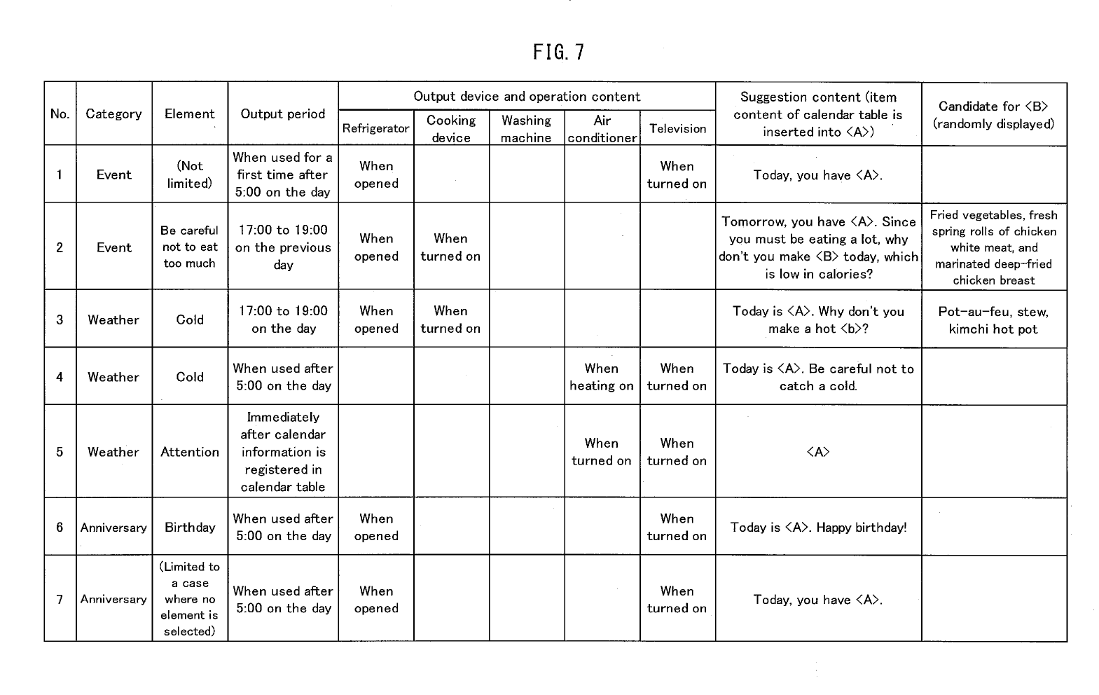

FIG. 7 is a view showing a lifestyle suggestion table of the suggestion system 1 in accordance with Embodiment 1 of the present invention. The following description will discuss the lifestyle suggestion table with reference to FIG. 7. The suggestion system 1 can be configured such that (i) the lifestyle suggestion table is inputted by a user by use of an input device or (ii) the lifestyle suggestion table is inputted by an administrator of the suggestion system 1. Alternatively, the suggestion system 1 can have another configuration.

The lifestyle suggestion table shown in FIG. 7 is an example in which suggestion information including suggestion content to be suggested by the suggestion system 1 to a user is shown in a table format. The suggestion content determining section 17 refers to the lifestyle suggestion table in order to determine whether or not there is suggestion content at a current time point. In a case where the suggestion content determining section 17 has determined that there is suggestion content at the current time point, the suggestion content determining section 17 refers to the lifestyle suggestion table again in order to determine suggestion content. As shown in FIG. 7, the lifestyle suggestion table includes items of “category”, “element”, “output period”, “output device and operation content”, “suggestion content”, and, as necessary, “candidate for <B>”. In other words, as shown in FIG. 7, the items of “category”, “element”, “output period”, “output device and operation content”, “suggestion content”, and, as necessary, “candidate for <B>” are associated with suggestion information. Further, serial numbers are assigned to respective rows (respective pieces of suggestion information) of the lifestyle suggestion table. Items to which an identical serial number is assigned are managed so as to be associated with each other.

The item “category” is information indicative of a category of suggestion content. The item “category” of the lifestyle suggestion table includes at least a part of the information stored in the item “category” of the calendar table described above.

The item “element” is information related to the “category”. Information that is set as the “element” of the lifestyle suggestion table serves as an option that can be selected when an inputter inputs calendar information.

The item “output period” (i) is a period that is set with reference to a period indicated by the “output period” of the calendar table described above and (ii) is information indicative of a period (notification period) during which suggestion content can be notified. For example, in the example shown in FIG. 7, an output period “when used for a first time after 5:00 on the day” is associated with a serial number “1”. This indicates that in a case where the “output period” of the calendar table is “2014/1/3”, suggestion content is outputted when a target electrical device is used (operated) for a first time after 5:00 on 2014/1/3.

The item “output device and operation content” is information that serves as a trigger for (i) a process in which the electrical device 20 notifies suggestion content or (ii) a process in which the suggestion content determining section 17 determines suggestion content. For example, in FIG. 7, an output device and operation content that are set as the “output device and operation content” of the serial number “1” are “refrigerator” and “when opened”, respectively. This indicates that, when the refrigerator is opened, (i) the refrigerator notifies suggestion content or (ii) the suggestion content determining section 17 determines suggestion content. As shown in FIG. 7, suggestion content that can be suggested varies for each “output device” of the “output device and operation content”. For example, suggestion content that can be suggested by the “refrigerator” is suggestion content associated with a serial number “1”, “2”, “3”, “6”, or “7”. Meanwhile, suggestion content that can be suggested by the “air conditioner” is suggestion content associated with a serial number “4” or “5”. As described above, the suggestion system 1 is a system in which suggestion content is determined for each output device (notification device).

The item “suggestion content” is information indicative of content to be suggested by the notification device. For example, in FIG. 7, “suggestion content” of the Ser. No. “1” is “Today, you have <A>.” Text that is set as the “item content” of the calendar table described above is to be inserted into <A>. Accordingly, the suggestion content includes at least a part of the information stored in the “input content” included in the calendar information.

The item “candidate for <B>” is a candidate for text to be inserted into <B> of the item “suggestion content”. For example, the suggestion system 1 can be configured such that, in the lifestyle suggestion table, a plurality of pieces of text are set as options for the item “candidate for <B>”, and any of the plurality of pieces of text thus set is randomly selected and inserted into <B> of the “suggestion content”. For example, in FIG. 7, “suggestion content” of the serial number “2” is “Tomorrow, you have <A>. Since you must be eating a lot, why don't you make <B> today, which is low in calories?”, and options for the “candidate for <B>” are “fried vegetables, fresh spring rolls of chicken white meat, and marinated deep-fried chicken breast”. In a case where the “fried vegetables” is selected from the options “fried vegetables, fresh spring rolls of chicken white meat, and marinated deep-fried chicken breast”, the suggestion content is “Tomorrow, you have <A>. Since you must be eating a lot, why don't you make fried vegetables today, which is low in calories?” Note that the number of pieces of text to be set as an option for the “candidate for <B>” can be one (1).

(Process of Notifying Suggestion Content)

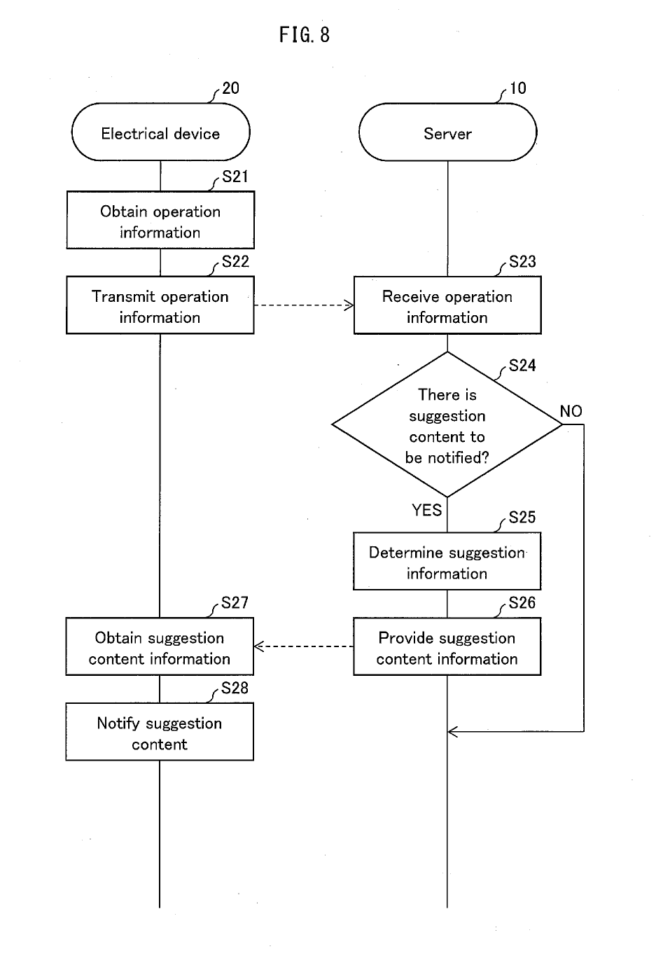

FIG. 8 is a sequence diagram showing a flow of a process of notifying suggestion content in the suggestion system 1 in accordance with Embodiment 1 of the present invention. The following discusses, with reference to FIG. 8, a process in which the suggestion system 1 notifies suggestion content. Note that a process (steps S24 and S25) of determining suggestion content will be described later in detail with reference to another drawing.

(Step S21)

First, the operation receiving section 23 of the electrical device 20 supplies, to the operation information output section 24, operation information indicative of content of an operation received from a user. As described above, the operation information also includes information indicative of the electrical device 20.

(Step S22)

The operation information output section 24 of the electrical device 20 (i) obtains the operation information supplied from the operation receiving section 23 and (ii) transmits the operation information to the server 10 via the electrical device communicating section 21.

(Step S23)

The operation information obtaining section 16 of the server 10 receives, via the server communicating section 11, the operation information transmitted from the electrical device 20. The operation information obtaining section 16 supplies, to the suggestion content determining section 17, the operation information thus received.

(Step S24)

Upon receipt of the operation information from the operation information obtaining section 16, the suggestion content determining section 17 of the server 10 starts a process of determining suggestion content. First, the suggestion content determining section 17 determines whether or not there is suggestion content to be notified, by referring to (i) the operation information thus obtained, (ii) the calendar table stored in the calendar table storage section 13, and (iii) the lifestyle suggestion table stored in the lifestyle suggestion table storage section 14.

(Step S25)

In a case where the suggestion content determining section 17 has determined in the step S24 that “there is suggestion content to be notified” (step S24: YES), the suggestion content determining section 17 (i) determines suggestion content (a step of determining suggestion content) and (ii) supplies, to the suggestion content providing section 18, suggestion content information indicative of the suggestion content thus determined.

(Step S26)

The suggestion content providing section 18 transmits, via the server communicating section 11 to the electrical device 20 which is an electrical device indicated by the operation information, the suggestion content information obtained from the suggestion content determining section 17 (a step of providing suggestion content).

(Step S27)

The suggestion content obtaining section 25 of the server 10 receives, via the electrical device communicating section 21, the suggestion content information transmitted from the server 10. The suggestion content obtaining section 25 supplies, to the notifying section 26 of the electrical device 20, the suggestion content information thus received.

(Step S28)

The notifying section 26 of the electrical device 20 (i) obtains the suggestion content information supplied from the suggestion content obtaining section 25 and (ii) notifies the suggestion content indicated by the suggestion content information.

Note that in a case where the suggestion content determining section 17 determines in the step S24 that “there is no suggestion content to be notified” (step S24: NO), the process shown in FIG. 8 is ended.

(Details of Process of Determining Suggestion Content)

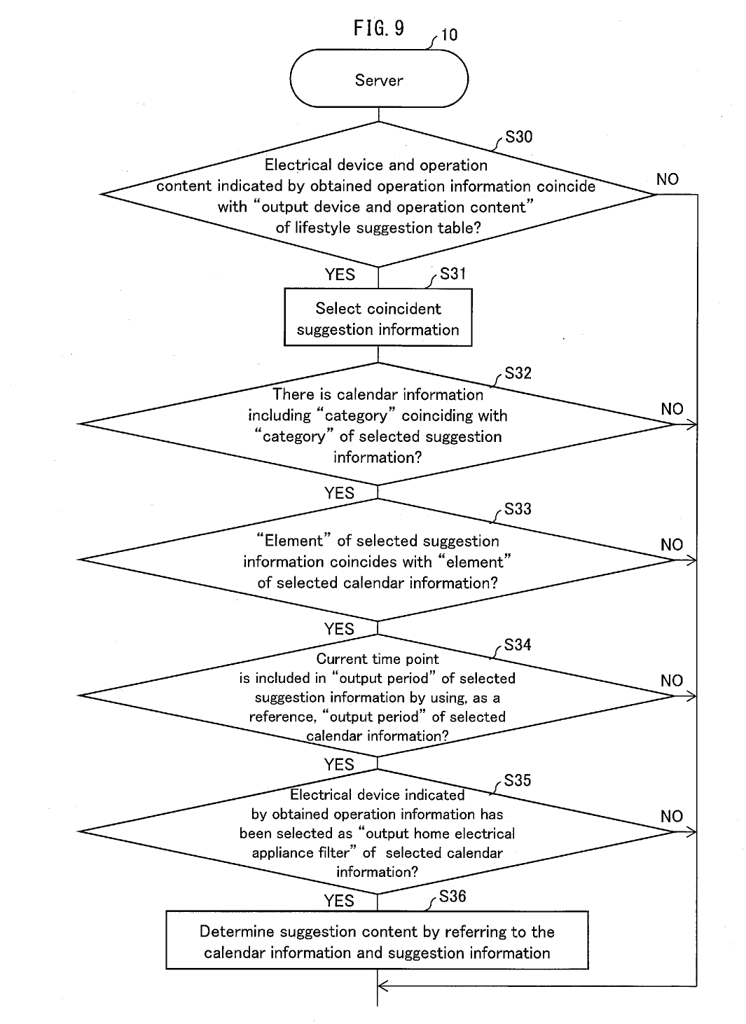

FIG. 9 is a sequence diagram showing a flow of a process of determining suggestion content in the suggestion system 1 in accordance with Embodiment 1 of the present invention. The following description will discuss details of the steps S24 and S25 with reference to FIG. 9.

(Step S30)

First, the suggestion content determining section 17 of the server 10 determines whether or not an electrical device and operation content which are indicated by obtained operation information coincide with an output device and operation content that are set as the “output device and operation content” of the lifestyle suggestion table. For example, in a case where (i) the electrical device indicated by the obtained operation information is a “refrigerator” and the operation content indicated by the obtained operation information is “opened”, the suggestion content determining section 17 determines whether or not the “refrigerator” and “when opened” are included as the item “output device and operation content” of the lifestyle suggestion table shown in FIG. 7.

(Step S31)

In a case where the suggestion content determining section 17 has determined in the step S30 that “the electrical device and the operation content which are indicated by the obtained operation information coincide with the output device and the operation content that are set as the ‘output device and operation content’ of the lifestyle suggestion table”, the suggestion content determining section 17 selects coincident suggestion information. More specifically, the “coincident suggestion information” indicates suggestion information associated with the “output device and operation content” coinciding with the electrical device and the operation content which are indicated by the obtained operation information. For example, in a case where the electrical device and the operation content which are indicated by the obtained operation information are the “refrigerator” and “opened”, respectively, the suggestion content determining section 17 selects, from the lifestyle suggestion table shown in FIG. 7, suggestion information associated with each of the serial numbers “1”, “2”, “3”, “6”, and “7”.

(Step S32)

The suggestion content determining section 17 determines, by referring to the calendar table, whether or not there is calendar information including a “category” which coincides with a “category” of the suggestion information selected in the step S31. For example, the suggestion content determining section 17 determines whether or not, in the suggestion information selected in the step S31, there is calendar information including an “event” which is a “category” associated with the serial number “1”.

(Step S33)

In a case where the suggestion content determining section 17 has determined in the step S32 that “there is calendar information including a ‘category’ which coincides with the ‘category’ of the suggestion information selected in the step S31” (step S32: YES), the suggestion content determining section 17 selects the calendar information which coincides, in the step S32, in “category” with the suggestion information selected in the step S31. The suggestion content determining section 17 then determines whether or not an “element” of the selected suggestion information coincides with an “element” of the selected calendar information. For example, the suggestion content determining section 17 selects, from the calendar table shown in FIG. 4, calendar information associated with each of serial numbers “1”, “7”, and “8” each of which includes an “event” as the “category”. The suggestion content determining section 17 then determines whether or not “(not limited)” which is an “element” associated with the serial number “1” of the lifestyle suggestion table coincides with an “element” associated with each of the serial numbers “1”, “7”, and “8” of the calendar table.

(Step S34)

In a case where the suggestion content determining section 17 has determined in the step S33 that “the ‘element’ of the selected suggestion information coincides with the ‘element’ of the selected calendar information”, the suggestion content determining section 17 determines, with reference to an “output period” of the selected calendar information, whether or not a current time point is included in an “output period” of the selected suggestion information. For example, the suggestion content determining section 17 selects, from the calendar table, calendar information associated with the serial number “7” which coincides in “element” with the serial number “1” of the lifestyle suggestion table. The suggestion content determining section 17 then determines, with reference to “2014/4/8” which is the “output period” of the selected calendar information, whether or not a current time point is included in an output period “when used for a first time after 5:00 on the day (2014/4/8)” which is the “output period” of the selected suggestion information. Further, for example, in a case where (i) the “output period” of the selected calendar information is “2014/4/8” and (ii) the “output period” of the selected suggestion information is “17:00 to 19:00 on the previous day”, the suggestion content determining section 17 determines whether or not a current time point is included in an output period “17:00 to 19:00 on 2014/4/8”.

(Step S35)

In a case where the suggestion content determining section 17 has determined in the step S34 that “a current time point is included in the ‘output period’ of the selected suggestion information, with reference to the ‘output period’ of the selected calendar information”, the suggestion content determining section 17 determines whether or not the electrical device indicated by the obtained operation information has been selected as an “output home electrical appliance filter” of the selected calendar information. For example, in a case where a current time point is “2014/4/8 8:00”, the current time point is included in an output period “when used for a first time after 5:00 on 2014/4/8” which is the “output period”. Accordingly, the suggestion content determining section 17 determines whether or not the “refrigerator” which is the electrical device indicated by the operation information is selected as an “output home electrical appliance filter” of the serial number “7” of the calendar table.

(Step S36)

In a case where the suggestion content determining section 17 has determined in the step S35 that “the electrical device indicated by the obtained operation information is selected as the ‘output home electrical appliance filter’ of the selected calendar information”, the suggestion content determining section 17 determines suggestion content by inserting, into <A> of “suggestion content” of the selected suggestion information, text that is set as “item content” of the selected calendar information.

Note that, in the step S36, the suggestion content determining section 17 determines suggestion content by referring to the “candidate for <B>” as necessary. For example, in a case where the operation information obtained by the suggestion content determining section 17 indicates the “refrigerator”, since it has been determined in the step S35 that the “refrigerator” is selected as the “output home electrical appliance filter” of the selected serial number “7” of the calendar table, the suggestion content determining section 17 (i) inserts, into <A> of the suggestion content of the selected serial number “1”, “Ichiro's entrance ceremony” which is “item content” of the selected serial number “7” and (ii) thus determines, as the suggestion content, “Today, you have Ichiro's entrance ceremony”.

Meanwhile, there is no suggestion content to be notified by the suggestion content determining section 17 in any of the following cases: (i) a case where the suggestion content determining section 17 determines in the step S30 that “the electrical device and the operation content which are indicated by the obtained operation information do not coincide with the output device and the operation content that are set as the ‘output device and operation content’ of the lifestyle suggestion table” (step S30: NO); (ii) a case where the suggestion content determining section 17 determines in the step S32 that “there is no calendar information including a ‘category’ which coincides with the ‘category’ of the suggestion information selected in the step S31” (step S32: NO); (iii) a case where the suggestion content determining section 17 determines in the step S33 that “the ‘element’ of the selected calendar information does not coincide with the ‘element’ of the selected suggestion information” (step S33: NO); (iv) a case where the suggestion content determining section 17 determines in the step S34 that “a current time point is not included in the ‘output period’ of the selected suggestion information, with reference to the ‘output period’ of the selected calendar information” (step S34: NO); and (v) a case where the suggestion content determining section 17 determines in the step S35 that “the electrical device indicated by the obtained operation information is not selected as the ‘output home electrical appliance filter’ of the selected calendar information” (step S35: NO). Therefore, in the above cases, the process shown in FIG. 7 is ended.

Note that the suggestion content that has been determined in the step S36 is provided to the electrical device indicated by the operation information. For example, in a case where (i) the suggestion content determining section 17 has determined the suggestion content to be “Today, you have Ichiro's entrance ceremony” and (ii) the operation information indicates “refrigerator”, the suggestion content determining section 17 transmits, to the refrigerator 20a via the server communicating section 11, suggestion content information indicating the suggestion content. In a case where the refrigerator 20a receives the suggestion content information from the server 10, the refrigerator 20a outputs, from a speaker which is the notifying section, an artificial voice saying “Today, you have Ichiro's entrance ceremony”, which is the suggestion content.

Another method of notifying suggestion content is a method in which in a case where a device for notifying suggestion content is a television, text (e.g., “Today is Daikan. Why don't you make a hot pot-au-feu?”) indicating the suggestion content is displayed on a screen of the television when the television is turned on. Still another example of the method of notifying suggestion content is a method in which in a case where a device for notifying suggestion content is a washing machine, an artificial voice (e.g., “Since it's raining today, please use a drier.”) indicating the suggestion content is outputted from a speaker of the washing machine when a lid of the washing machine is opened. More generally, notification of suggestion content by use of the electrical device can be carried out by using an artificial voice outputted from the electrical device, an image displayed by the electrical device, light emitted from the electrical device, vibration of the electrical device, a movement of the electrical device, or the like, or a combination thereof.

The suggestion content determining section 17 can be configured such that in a case where the suggestion content determining section 17 has selected, in the step S31, a plurality of pieces of suggestion information associated with a plurality of serial numbers (e.g., the serial numbers “1” and “2”), the suggestion content determining section 17 carries out the processes in the steps S32 through S35 by referring to all of the plurality of pieces of suggestion information thus selected.

The suggestion content determining section 17 can also carry out the processes in the steps S32 through S35 in a different order.

As described above, according to the suggestion system 1 in accordance with Embodiment 1, the server 10 (i) obtains calendar information associated with a user and (ii) determines, by referring to the calendar information, suggestion content to be suggested to the user. This makes it possible to make a suggestion that is more convenient for the user.

Further, upon receipt of operation information from an electrical device 20 operated by a user, the server 10 determines suggestion content to be suggested to the user. This makes it possible to make a suggestion to the user at a timing suitable for the user.

The server 10 transmits suggestion information to an electrical device 20 that has transmitted operation information. Accordingly, it is possible to notify suggestion content by using an electrical device 20 positioned near a user, and this increases convenience for the user.

As is clear from the above description, suggestion content that is determined by the suggestion content determining section 17 can vary depending on the “category”, the “element”, and the “output device and operation content”. Further, the suggestion content can also vary depending on the “output period”. As such, the suggestion content determining section 17 can generate various types of suggestion content in view of a matter that can occur in future. This makes it possible to (i) suitably prompt the user's notice and (ii) realize an electrical device for which the user has an affinity.

Note that it can be understood that the “output period” of the lifestyle suggestion table is managed by the suggestion content determining section 17 so as to be associated, as the lifestyle suggestion table, with suggestion information, and during the “output period” of the lifestyle suggestion table, the suggestion content providing section 18 provides, to the electrical device 20, suggestion content information indicating suggestion content.

The server 10 of Embodiment 1 can be made up of a plurality of servers. For example, in a case where the server 10 is made up of a server A and a server B, the server 10 can be configured such that (i) the server A includes a server communicating section 11 and a server controlling section 12 and (ii) the server B includes a calendar table storage section 13 and a lifestyle suggestion table storage section 14. Alternatively, for example, in a case where the server 10 is made up of a server A, a server B, and a server C, the server 10 can be configured such that (i) the server A includes a server communicating section 11 and a server controlling section 12, (ii) the server B includes a calendar table storage section 13, and (iii) the server C includes a lifestyle suggestion table storage section 14.

### Embodiment 2

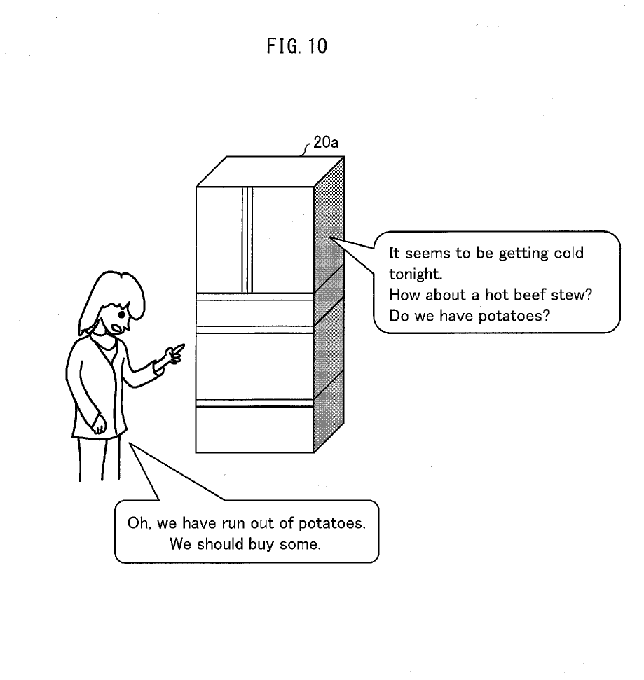

The following description will discuss another embodiment of the present invention with reference to FIG. 10. Note that, for convenience, members identical in function to those described in the above embodiment are given identical reference numerals, and descriptions of those members are omitted.

According to Embodiment 2, for example, in the lifestyle suggestion table shown in FIG. 7, (i) “It seems to be <A> tonight. How about a hot <B>? Do we have <C>?” is set as the item “suggestion content” and (ii) “pot-au-feu, beef stew, kimchi hot pot” are set as options for the “candidate for <B>”. Moreover, according to Embodiment 2, (i) the lifestyle suggestion table further includes an item “candidate for <C>” which is to be selected in accordance with text selected from the options for the “candidate for <B>” and (ii) “potatoes, beef, onions, roux” and the like are set as options for the “candidate for <C>” in a case where the “beef stew” is selected as the “candidate for <B>”. Further, it is assumed that “getting cold” is set as the item “item content” in the calendar table shown in FIG. 4.

In such a situation, a suggestion content determining section 17 inserts, into the suggestion content, text “getting cold” which is to be inserted into <A>, by referring to the lifestyle suggestion table and the calendar table described above. The suggestion content determining section 17 then randomly selects text from the options for the “candidate for <B>”. In a case where the suggestion content determining section 17 selects the “beef stew”, the suggestion content determining section 17 randomly selects text from the options for the “candidate for <C>”. For example, in a case where the suggestion content determining section 17 selects “potatoes” from the options for the “candidate for <C>”, the suggestion content determining section 17 determines, as the suggestion content, “It seems to be getting cold tonight. How about a hot beef stew? Do we have potatoes?” Then, a suggestion content providing section 18 supplies, to an electrical device 20, suggestion content information indicative of the suggestion content. FIG. 10 illustrates how a refrigerator 20a notifies the suggestion content in a case where the electrical device 20 for notifying the suggestion content is the refrigerator 20a. FIG. 10 is a view illustrating how the refrigerator 20a notifies the suggestion content in a suggestion system 1 in accordance with Embodiment 2 of the present invention.

As illustrated in FIG. 10, the refrigerator 20a outputs the suggestion content “It seems to be getting cold tonight. How about a hot beef stew? Do we have potatoes?” by using an artificial voice. Accordingly, the suggestion system 1 can notify the suggestion content and prompt a user to check whether or not the user has ingredients for making a beef stew.

As described above, in Embodiment 2, the lifestyle suggestion table includes an additional item and a user is asked a question by using any of a plurality of candidates included in the additional item. Note that the question includes a matter that is necessary to carry out what is suggested by suggestion content. That is, the suggestion system 1 in accordance with Embodiment 2 can notify a user a matter that is necessary to carry out what is suggested by the suggestion content. This makes it possible to make a more suitable suggestion prompting the user to notice a matter concerning the future.

### Embodiment 3

The following description will discuss another embodiment of the present invention. Note that, for convenience, members identical in function to those described in the above embodiments are given identical reference numerals, and descriptions of those members are omitted.

According to the above embodiments, the suggestion system 1 provides suggestion content to an electrical device that has transmitted operation information. Note, however, that the suggestion system 1 can be configured to provide suggestion content to an electrical device that differs from the electrical device that has transmitted the operation information.

For example, a server 10 receives, from an LED lighting device, operation information indicative of “lighting up”. Upon receipt of the operation information, the server 10 determines suggestion content. Then, the server 10 provides the suggestion content to an air conditioner that is installed in the same room as the LED lighting device. A fact that the server 10 obtains, from the LED lighting device, the operation information indicative of “lighting up” means that a user is in the room in which the LED lighting device is installed. Accordingly, a suggestion system 1 in accordance with Embodiment 3 can prompt the user's notice at a suitable timing by controlling the air conditioner installed in the same room as the LED lighting device is installed so that the air conditioner notifies the suggestion content.

According to Embodiments 1 and 2, the electrical device capable of transmitting operation information includes the notifying section 26. Note, however, that, according to Embodiment 3, the suggestion system 1 can be configured such that (i) an electrical device including no notifying section 26 transmits operation information and (ii) the server 10 receives the operation information. The suggestion system 1 having such a configuration can also make a suggestion that prompts a user to notice a matter concerning the future.

### Embodiment 4

The following description will discuss another embodiment of the present invention. Note that, for convenience, members identical in function to those described in the above embodiments are given identical reference numerals, and descriptions of those members are omitted.

In the calendar table shown in FIG. 4, an “inputter” associated with a serial number “2” is “Company A” which provides information on weather, and is a user B of a suggestion system 1 who differs from a user A to whom suggestion content is to be notified. Thus, the suggestion system 1 in accordance with Embodiment 4 can be configured to obtain calendar information from the user B which differs from the user A to whom suggestion content is to be notified. In a case where the suggestion system 1 has the above configuration, the suggestion system 1 can generate various types of suggestion content, and this makes it possible to suitably prompt the user A's notice.

Further, the user B can efficiently provide an advertisement by, for example, inputting calendar information on an advertisement (“Today is a special sale day” etc.). Accordingly, the suggestion system 1 in accordance with Embodiment 4 can prompt the user A's notice at a timing also suitable for the user B.

The suggestion system 1 can be configured such that the user A can set in advance an electrical device capable of outputting suggestion content to be generated by referring to calendar information inputted by the user B. For example, the suggestion system 1 can be configured such that the user A can limit, to an air conditioner, an electrical device capable of outputting suggestion content to be generated by referring to calendar information inputted by “Company A” that provides information on weather.

The server 10 can be configured to automatically update calendar information. For example, the server 10 can be configured to store information indicative of a link that provides information on weather, access the link at predetermined time intervals to thereby obtain the information on weather from the link, and manage, as calendar information, the information thus obtained.

### Embodiment 5

The server controlling section 12 of the server 10 and the electrical device controlling section 22 of the electrical device 20 can be realized by a logic circuit (hardware) provided in an integrated circuit (IC chip) or the like or can be alternatively realized by software as executed by a central processing unit (CPU).

In the latter case, the server 10 and the electrical device 20 each include a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### CONCLUSION

In a first aspect of the present invention, a server (10) includes: a calendar information obtaining section (15) for obtaining calendar information associated with a user; a suggestion content determining section (17) for determining suggestion content to be suggested to the user, by referring to the calendar information; and a suggestion content providing section (18) for providing suggestion content information, which is indicative of the suggestion content, to a notification device (electrical device 20) for notifying the suggestion content.

With the configuration, calendar information associated with a user is obtained and suggestion content to be suggested to the user is determined by referring to the calendar information. This makes it possible to make a suggestion that prompts the user to notice a matter concerning the future.

Note that the notification device indicates an electrical device including a notifying section for making a notification to a user.

In a second aspect of the present invention, the server can be configured such that, in the first aspect of the present invention, the suggestion content determining section manages a notification period such that the notification period is associated with the suggestion content, the notification period being a period during which it is possible to notify the suggestion content; and the suggestion content providing section provides, to the notification device, suggestion content information indicative of the suggestion content during the notification period.

With the configuration, the suggestion content determining section manages a notification period such that the notification period is associated with the suggestion content, the notification period being a period during which the suggestion content can be notified, and the suggestion content providing section provides, to the notification device, suggestion content information indicative of the suggestion content during the notification period. This makes it possible to prompt the user's notice at a suitable timing.

In a third aspect of the present invention, a server can further include, in the first or second aspect of the present invention, an operation information obtaining section (16) for obtaining operation information indicative of (i) an electrical device (20) with respect to which a user carried out an operation and (ii) content of the operation, the suggestion content determining section determining, in response to obtaining the operation information by the operation information obtaining section, suggestion content to be suggested to the user.

With the configuration, the server further includes the operation information obtaining section for obtaining operation information indicative of (i) an electrical device with respect to which a user has carried out an operation and (ii) content of the operation, and the suggestion content determining section determines suggestion content to be suggested to the user, upon receipt of the operation information by the operation information obtaining section. This makes it possible to make a suggestion to a user at a timing suitable for the user.

In a fourth aspect of the present invention, the server can be configured such that, in the third aspect of the present invention, the suggestion content determining section determines the suggestion content to be suggested to the user, by referring to the operation information obtained by the operation information obtaining section.

With the configuration, the suggestion content determining section determines suggestion content to be suggested to a user, by referring to the operation information obtained by the operation information obtaining section. This makes it possible to make a suggestion that is more convenient for the user.

In a fifth aspect of the present invention, the server can be configured such that, in the third or fourth aspect of the present invention, the suggestion content providing section provides the suggestion content information to the electrical device indicated by the operation information obtained by the operation information obtaining section.

With the configuration, the suggestion content providing section provides the suggestion content information to the electrical device indicated by the operation information obtained by the operation information obtaining section. This makes it possible to suitably prompt a user's notice.

In a sixth aspect of the present invention, the server can be configured such that, in the first through fifth aspects of the present invention, the suggestion content includes at least a part of input content of the calendar information.

With the configuration, the suggestion content includes at least a part of the input content of the calendar information. This makes it possible to make a suggestion that is more convenient for a user.

In a seventh aspect of the present invention, the server can be configured such that, in the sixth aspect of the present invention, the input content is managed by being classified into categories; and the suggestion content includes a suggestion according to a category of the input content.

With the configuration, the input content is managed by being classified into categories; and the suggestion content includes a suggestion according to a category of the input content. This makes it possible to make a suggestion that is more convenient for a user.

A suggestion method in accordance with an eighth aspect of the present invention includes the steps of: obtaining calendar information associated with a user; determining suggestion content to be suggested to the user, by referring to the calendar information; and providing suggestion content information, which is indicative of the suggestion content, to a notification device for notifying the suggestion content.

With the configuration, the suggestion method brings about an effect similar to that of the first aspect.

A suggestion system (1) in accordance with a ninth aspect of the present invention includes a server (10) and a notification device (20), the server including: a calendar information obtaining section (15) for obtaining calendar information associated with a user; a suggestion content determining section (17) for determining suggestion content to be suggested to the user, by referring to the calendar information; and a suggestion content providing section (18) for providing suggestion content information, which is indicative of the suggestion content, to a notification device for notifying the suggestion content, the notification device including: a suggestion content obtaining section (25) for obtaining the suggestion content information; and a notifying section (26) for notifying the suggestion content indicated by the suggestion content information obtained by the suggestion content obtaining section.

With the configuration, the suggestion system brings about an effect similar to that of the first aspect.

A notification device (20) in accordance with a tenth aspect of the present invention includes: an operation information output section (24) for outputting operation information indicative of an operation received from a user; a suggestion content obtaining section (25) for obtaining suggestion content information indicative of suggestion content that has been determined by referring to the operation information; and a notifying section (26) for notifying the suggestion content indicated by the suggestion content information obtained by the suggestion content obtaining section.

With the configuration, the notification device can realize the electrical device of the third aspect.

The server (10) and the notification device (20) in accordance with the foregoing aspects of the present invention may be realized by a computer. In this case, the present invention encompasses: a program for a server and a notification device which program causes a computer to operate as each section of the server and the notification device so that the server and the notification device can be each realized by the computer; and a computer-readable storage medium storing the control program therein.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to a suggestion system for notifying suggestion content by using an electrical device such as a home electrical appliance.

### REFERENCE SIGNS LIST

1: Suggestion system

2: Network

10: Server

11: Server communicating section

12: Server controlling section

13: Calendar table storage section

14: Lifestyle suggestion table storage section

15: Calendar information obtaining section

16: Operation information obtaining section

17: Suggestion content determining section

18: Suggestion content providing section

20: Electrical device (notification device)

21: Electrical device communicating section

22: Electrical device controlling section

23: Operation receiving section

24: Operation information output section

25: Suggestion content obtaining section

26: Notifying section

30: Calendar updated information input device

31: Device communicating section

32: Input receiving section

33: Input information output section

34: Display controlling section

35: Display section

1-11. (canceled)

12. A server comprising one or more processers,
the one or more processers obtaining calendar information,
the one or more processers determining suggestion content for each notification device by referring to the calendar information,
the one or more processers providing suggestion content information, which is indicative of the suggestion content, to the each notification device for notifying the suggestion content.

13. The server as set forth in claim 12, wherein
the one or more processers manage a notification period such that the notification period is associated with the suggestion content, the notification period being a period during which it is possible to notify the suggestion content.

14. The server as set forth in claim 12, wherein:
the one or more processers obtain operation information indicative of content of an operation that has been carried out by a user with respect to an electrical device; and
the one or more processers determine, after the one or more processers have obtained the operation information, suggestion content to be suggested to the user.

15. The server as set forth in claim 14, wherein the one or more processers determine the suggestion content to be suggested to the user, by referring to the operation information.

16. The server as set forth in claim 14, wherein:
the operation information is further indicative of the electrical device that has been operated by the user; and
the one or more processers provide the suggestion content information to the electrical device indicated by the operation information, the electrical device serving as the each notification device.

17. The server as set forth in claim 12, wherein the suggestion content includes at least a part of content of the calendar information.

18. The server as set forth in claim 17, wherein:
the content of the calendar information is managed by being classified into categories; and
the suggestion content includes a suggestion according to a category of the content.

19. A suggestion method comprising the steps of:
obtaining calendar information;
determining suggestion content for each notification device by referring to the calendar information; and
providing suggestion content information, which is indicative of the suggestion content, to the each notification device for notifying the suggestion content.

20. A suggestion system comprising a server and a notification device,
the server including one or more processers,
the one or more processers obtaining calendar information,
the one or more processers determining suggestion content for each notification device by referring to the calendar information,
the one or more processers providing suggestion content information, which is indicative of the suggestion content, to the each notification device for notifying the suggestion content,
the each notification device including:
a suggestion content obtaining section for obtaining the suggestion content information from the server; and
a notifying section for notifying the suggestion content indicated by the suggestion content information obtained by the suggestion content obtaining section.

21. A notification device comprising:
an operation information output section for outputting operation information indicative of an operation received from a user;
a suggestion content obtaining section for obtaining suggestion content information indicative of suggestion content that has been determined by referring to the operation information and calendar information; and
a notifying section for notifying the suggestion content indicated by the suggestion content information obtained by the suggestion content obtaining section.
